(19) United States
(12) Patent Application Publication
(10) Pub. No.: US 2017/0103542 A1
(43) Pub. Date: Apr. 13, 2017

(54) SYSTEMS AND METHODS FOR GRADING THE APPEARANCE OF SEEDS

(71) Applicant: Remington Seeds, LLC, Remington, IN (US)

(72) Inventor: Daniel Hallberg, Kouts, IN (US)

(21) Appl. No.: 15/210,488

(22) Filed: Jul. 14, 2016

Related U.S. Application Data
(60) Provisional application No. 62/240,992, filed on Oct. 13, 2015.

(51) Int. Cl. G06T 7/40; G06T 7/00

(52) U.S. Cl. CPC G06T 7/408; G06T 7/0081; G06T 7/001; G06T 7/0018; G06T 2210/22; G06T 2207/10024; G06T 2207/20021; G06T 2207/30128; G06T 2207/20148

(57) ABSTRACT

Systems and methods for grading the appearance of seeds are disclosed. In an embodiments, a system comprises: a memory device configured to store one or more color thresholds and a processing device communicatively coupled to the memory device. The processing device is configured to: receive data corresponding to a digital image, wherein at least a portion of the digital image includes a representation of a plurality of seeds; divide the digital image into a plurality of sections; and compare an amount of color included in a section of the plurality of sections to a color threshold of the one or more color thresholds.

### PRIORITY CLAIM

This application claims the benefit of U.S. Provisional Application No. 62/240,992 filed on Oct. 13, 2015 and entitled “Systems and Method for Grading the Appearance of Seeds,” which is incorporated herein by reference in its entirety and for all purposes.

### TECHNICAL FIELD

The present disclosure generally relates to seeds. More specifically, the present disclosure relates to grading the appearance of seeds.

### BACKGROUND

Seeds are oftentimes graded on their appearance. In some instances, to grade the appearance of seeds, a person will take a sample set of seeds from a production batch and grade different parameters of the seed. Once the sample set is graded, the entire production batch will be assigned the grade given to the sample set.

If two different people are asked to grade the same sample set of seeds, they may be moderately consistent with the grade they assign to the sample. However, it is not uncommon for two different people to give two different grades to the same sample. Moreover, it is not uncommon for the same person to give two different grades to two samples that are objectively the same. As such, there is a need in the art for improved systems and methods for grading the appearance of seeds.

### SUMMARY

Embodiments of the present disclosure related to systems and methods for grading the appearance of seeds.

In Example 1, a system for grading the appearance of seeds comprises: a memory device configured to store one or more color thresholds; a processing device communicatively coupled to the memory device, the processing device configured to: receive data corresponding to a digital image, wherein at least a portion of the digital image includes a representation of a plurality of seeds; divide the digital image into a plurality of sections; and compare an amount of color included in a section of the plurality of sections to a color threshold of the one or more color thresholds.

In Example 2, a processor-implemented method for grading the appearance of seeds comprises: dividing, using a processing device, a digital image into a plurality of sections, wherein at least a portion of the digital image includes a representation of a plurality of seeds; comparing, using the processing device, an amount of color included in a section of the plurality of sections to a color threshold of the one or more color thresholds; and outputting, to a display device, a signal corresponding to the comparison of the amount of color to the color threshold.

In Example 3, a system for grading the appearance of seeds comprises: a memory device configured to store one or more color thresholds; a processing device communicatively coupled to the memory device, the processing device configured to: receive data corresponding to a digital image, wherein at least a portion of the digital image includes a representation of a plurality of seeds; receive at least one calibration parameter corresponding to the digital image; adjust a color threshold of the one or more color thresholds based on the received at least one calibration parameter; and compare an amount of color of the digital image to the adjusted color threshold.

As the terms are used herein with respect to ranges of measurements (such as those disclosed immediately above), “about” and “approximately” may be used, interchangeably, to refer to a measurement that includes the stated measurement and that also includes any measurements that are reasonably close to the stated measurement, but that may differ by a reasonably small amount such as will be understood, and readily ascertained, by individuals having ordinary skill in the relevant arts to be attributable to measurement error, differences in measurement and/or manufacturing equipment calibration, human error in reading and/or setting measurements, adjustments made to optimize performance and/or structural parameters in view of differences in measurements associated with other components, particular implementation scenarios, imprecise adjustment and/or manipulation of objects by a person or machine, and/or the like.

As used herein, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

Although the term “block” may be used herein to connote different elements illustratively employed, the term should not be interpreted as implying any requirement of, or particular order among or between, various steps disclosed herein unless and except when explicitly referring to the order of individual steps. Additionally, a “set” or “group” of items (e.g., inputs, algorithms, data values, etc.) may include one or more items, and, similarly, a subset or subgroup of items may include one or more items.

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 is a block diagram depicting a system for grading the appearance of seeds, in accordance with embodiments of the present invention.

FIG. 2 is a block diagram depicting another system for grading the appearance of seeds, in accordance with embodiments of the present invention.

FIG. 3 is an image of a set of seeds that is graded, in accordance with embodiments of the present invention.

FIG. 4 is an image of another set of seeds that is graded, in accordance with embodiments of the present invention.

FIGS. 5A-5B are images of a single set of seeds that were imaged using different calibration parameters.

FIG. 6 is a chart illustrating, for a plurality of sample sets of seeds, a comparison between a seller's grade of a sample set of seeds using the embodiments disclosed herein and a buyer's grade for the same set of seeds.

FIG. 7 is a flow diagram depicting a method for grading the appearance of seeds, in accordance with embodiments of the present invention.

While the disclosed subject matter is amenable to various modifications and alternative forms, specific embodiments have been shown by way of example in the drawings and are described in detail below. The intention, however, is not to limit the disclosure to the particular embodiments described. On the contrary, the disclosure is intended to cover all modifications, equivalents, and alternatives falling within the scope of the disclosure as defined by the appended claims.

### DETAILED DESCRIPTION

A seller of seeds oftentimes will want seeds that have desirable coloring for the specific type of seed that they're selling. If the seed has a desirable coloring, then a consumer, wholesaler and/or retailer may be more likely to purchase the seed, which will lead to increased sales. As such, after seeds are collected, the collected seeds may be sprayed with desirable coloring for the specific type of seed, in order to increase the desirability of the seeds. For example, in some instances, a seed may be more desirable if it has a green coloring, as opposed to a yellowish-brown coloring. Accordingly, these types of seeds may be sprayed with green coloring before they are transported to a wholesaler. If the wholesaler determines that the received seeds have a sufficient amount of green coloring, then the wholesale may accept the seed shipment. However, if the wholesale determines that the received seeds do not have a sufficient amount of green coloring, then the wholesale may reject the seed shipment. This can result in added costs for the company providing the seeds to the wholesaler. Therefore, if the company shipping the seeds to the wholesaler could tell before the shipment takes place whether the seeds will be rejected by a wholesaler, the company could respray the seeds, thereby reducing the likelihood and/or ensuring that the seeds will not be rejected by the wholesaler. The embodiments provided herein may provide a solution this problem by disclosing systems and methods for objectively determining the coloring of seeds.

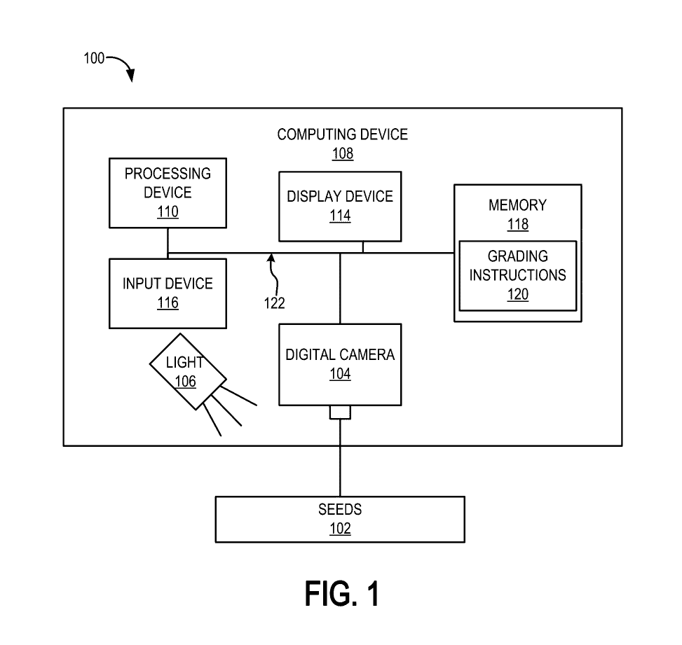

FIG. 1 is a block diagram depicting a system 100 for grading the appearance of seeds 102, in accordance with embodiments of the present invention. The system 100 includes a plurality of seeds 102. One or more parameters of the plurality of seeds 102 are subject to being graded. In embodiments, the color of the seeds 102 is graded. In embodiments, grading the color of the seeds 102 includes determining whether the seeds 102 have a sufficient amount of desirable coloring and/or too much undesirable coloring. If the seeds 102 have a sufficient amount of desirable coloring, the seeds 102 may be given a passing grade. If, on the other hand, the seeds 102 do not have a sufficient amount of desirable coloring and/or the seeds 102 have too much undesirable coloring, the seeds 102 may be given a failing grade. If the seeds 102 are given a failing grade, the seeds 102 may be resprayed to increase the desirable coloring of the seeds 102. In embodiments, a desirable coloring may be green while an undesirable coloring may be a yellowish-brown coloring.

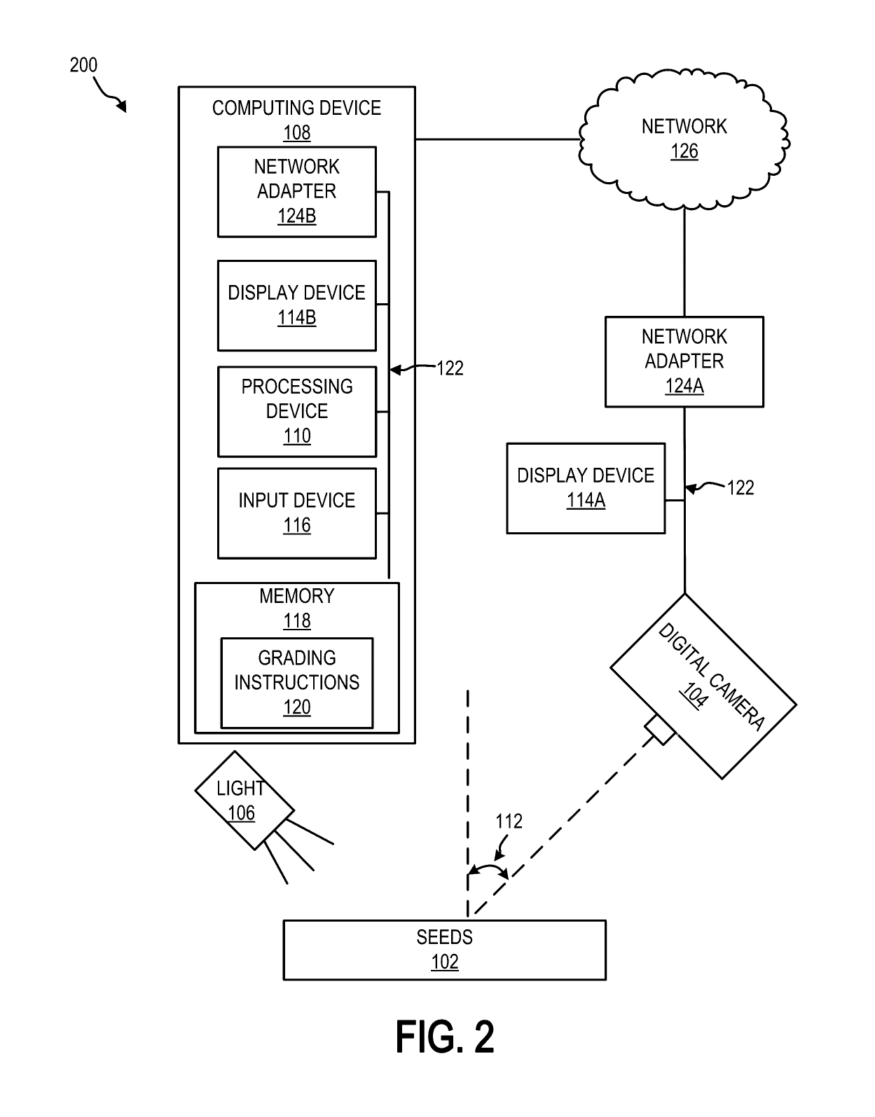

In embodiments, the system 100 includes a digital camera 104 and a light 106. The digital camera 104 takes a digital image of the seeds 102, so that the seeds 102 can be graded. When taking a digital image of the seeds 102, the light 106 provides lighting for the digital image. In embodiments, the digital camera 104 and the light 106 may be part of a single unit. For example, the light 106 may be incorporated into the digital camera 104 and/or the light 106 and the digital camera 104 can be incorporated into a computing device 108, as shown in FIG. 1. In other embodiments, the digital camera 104 and the light 106 may be separate units, as shown in FIG. 2.

In embodiments, the same digital camera 104 may take an image of the seeds 102 using different parameters and/or different digital cameras 104 may be used to take an image of the seeds 102 that have different parameters. That is, digital cameras with different megapixels, focal lengths, apertures, shutter speeds, sensitivities/ISOs, white balances, focus points/area and focus modes (e.g., single, continuous, or manual) may be used as the digital camera 104. For example, the digital camera 104 may be a 5 megapixel digital camera, 8 megapixel digital camera, 10 megapixel digital camera, 12 megapixel digital camera, 15 megapixel digital camera and/or the like. However, these are only examples and not meant to be limiting.

In addition to varying the digital camera parameters, the amount of light incident on the seeds 102, the angle of the digital camera 104 relative to the seeds 102 and the distance of the digital camera 104 from the seeds 102 can also vary when taking a digital image of the seeds 102. These variables, along with the digital camera parameters and size of the digital image, are referred to herein as calibration parameters and may be input into the processing device 110 for use in determining a grading for the seeds 102, as discussed below.

The amount of light incident on the seeds 102 may be the amount of illuminance on the seeds 102 and/or the luminous flux of the light 106. For the luminous flux of the light 106, the distance of the light 106 from the seeds 102 and the type of light 106 (i.e., a point source, a directional source, etc.) can be used to determine the amount of illuminance on the seeds 102.

The angle of the digital camera 104 relative to the seeds 102 may be the angle 112 between the normal of the lens of the digital camera 104 and the normal of the surface of the seeds 102. For example, in FIG. 1, the angle 112 between the normal of the lens of the digital camera 104 and the normal of the surface of the seeds 102 is zero degrees. As another example, in FIG. 2, the angle 112 between the normal of the lens of the digital camera 104 and the normal of the surface of the seeds 102 is Θ degrees, which is non-zero.

In embodiments, the system 100 may include a display device 114. In embodiments, the display device 114 displays the digital image taken by the digital camera 104. After the digital image is taken and displayed on the display device 114, in embodiments, the digital image can be cropped by a user or according to a predefined setting. The size of the cropped digital image can be used to standardize the digital image, as discussed in more detail below. In embodiments, the display device 114 may be a cathode ray tube (CRT) display, a liquid crystal display (LCD) display, a plasma display, a light-emitting diode (LED) display or an organic light-emitting diode (OLED) display. These are only examples, however, and not meant to be limiting. In embodiments, the display device 114 can be incorporated into a computing device 108. Alternatively or additionally, in embodiments, the display device 114 can be incorporated into the digital camera 104.

In embodiments, the system 100 includes a user input device 116. The user input device 116 may be used to input the calibration parameters discussed above. Additionally, the user input device 116 may be used to input a first color, a second color, a first color threshold, a second color threshold, etc., which are discussed in more detail below. The user input device 116 may include a mouse, a keyboard, a touchscreen, a combination thereof and/or the like.

The system 100 also includes a processing device 110, memory 118 and grading instructions 120. The processing device 110 may be, include, or be included in, an electrical processor, a software processor, a general purpose microprocessor and/or a special purpose microprocessor, and may include a sole processor or one of multiple processors or cores.

The memory 118 can be in the form of volatile and/or nonvolatile memory and may be removable, nonremovable, or a combination thereof. Media examples include Random Access Memory (RAM); Read Only Memory (ROM); Electronically Erasable Programmable Read Only Memory (EEPROM); flash memory; optical or holographic media; magnetic cassettes, magnetic tape, magnetic disk storage or other magnetic storage devices; data transmissions; and/or any other medium that can be used to store information and can be accessed by a processing device 110 such as, for example, quantum state memory, and/or the like. Grading instructions 120 may be programmed on the memory 118 using any number of different programming environments, including various languages, development kits, frameworks, and/or the like. Some or all of the functionality contemplated herein may also, or alternatively, be implemented in hardware and/or firmware.

In embodiments, the grading instructions 120 may include instructions that instruct the processing device 110 to receive the digital image of the seeds 102, taken by the digital camera 104, and process the digital image according to the grading instructions 120, which are stored on memory 118.

In embodiments, the grading instructions 120 may include instructions that instruct the processing device 110 to crop the received digital image to a standardized size. For example, the processing device 110 may be configured, by the grading instructions, to crop the digital image to 100×100 pixels, 200×200 pixels, 300×300 pixels, 300×200 pixels, 400×300 pixels and/or the like. However, this is only an example and not meant to be limiting. Additionally or alternatively, in embodiments, if the digital image contains portions that do not include the seeds 102, the grading instructions 120 may include instructions that instruct the processing device 110 to determine which portions of the digital image include the seeds 102 using, for example, one or more edge detection algorithms, and crop out the portions of the digital image that do not include the seeds 102. In other embodiments, a user may manually crop the digital image so that the digital image only includes portions of seeds. As such, in embodiments, the processing device 110 may perform one or more of the following instructions of the grading instructions 120 discussed below on only the portions of the digital image that include the seeds 102

In embodiments, the grading instructions 120 may include instructions that instruct the processing device 110 to divide the received digital image into a plurality of sections. For example, processing device 110 may divide the digital image into the digital image's constituent pixels. That is, if a digital image is 100×100 pixels, the digital image will have 10,000 segments after the received digital image is divided by the processing device 110. As another example, the processing device 110 may divide the digital image into 2×2 sections, 4×4 sections, 6×6 sections, 8×8 sections, 10×10 sections and/or the like. That is, if the digital image is 100×100 pixels, and the processing device 110 is configured to divide the digital image into 20×20 sections, each section will be 5×5 pixels. As even another example, the processing device 110 may divide the digital image into sections based on the resulting size of the divided sections. For example, the processing device 110 may be configured to divide the digital image into sections, wherein each section is 2×2 pixels. Accordingly, if the digital image is 100×100 pixels, then the processing device 110 may divide the digital image into 2,500 sections. Alternatively, if the digital image is 200×200 pixels, then the processing device may divide the digital image into 10,000 sections. However, these are only examples and not meant to be limiting. Instead, the digital image may be divided into sections using any other known method.

In embodiments, the grading instructions 120 may include instructions that instruct the processing device 110 to determine an amount of one or more colors in the digital image. In embodiments, the grading instructions 120 may instruct the processing device 110 to determine the amount of one or more colors in each section of the digital image or in a subset of sections of the digital image. To determine an amount of color in a section and/or a subset of sections, the processing device 110 may be configured to determine the 8-bit number that represents an amount of a primary color included in the section. For example, the processing device 110 may determine an amount of one or more primary colors included in each pixel of the digital image. In embodiments, the amount of one or more primary colors may be based on the 256×256×256 scale (i.e., on an 8×8×8 bit scale). That is, each primary color may be represented by 1 of 256 different numbers, which corresponds to a specific amount of the primary color in the pixel.

In embodiments, the grading instructions 120 may include instructions that instruct the processing device 110 to compare an amount of one or more colors (e.g., the determined amount of color) in the digital image to a threshold. To do so, in embodiments, the grading instructions 120 may instruct the processing device 110 to compare an amount of one or more colors (e.g., one or more of the determined amounts) in each section or subset of sections to a threshold. For example, if the digital image is divided into 100 sections, an amount of one or more colors in 25 sections, 50 sections, 75 sections, 100 sections and/or the like may be compared to a threshold.

In embodiments, the processing device 110 may compare an amount of one or more colors (e.g., the determined amount of one or more colors) to a respective threshold that corresponds to the respective color of the one or more colors. For example, if the processing device 110 determines the digital image and/or a section of the digital image to have an amount of red, the amount of red may be compared to a red threshold. Further, in embodiments, if the processing device 110 determines the digital image and/or a section of the digital image to have an amount of blue, the amount of blue may be compared to a blue threshold. And, in embodiments, if the processing device 110 determines the digital image and/or a section of the digital image to have an amount of green, the amount of green may be compared to a green threshold. In embodiments, the threshold may be based on the 256×256×256 scale (i.e., on an 8×8×8 bit scale). For example, a red threshold, a green threshold and/or a blue threshold may be 10, 20, 30, 40, 50, 60, 70, 80, 90, 100, 110, 122, 130, 140, 150, 160, 170, 180, 190, 200, 210, 220, 230, 240, 250 and/or the like.

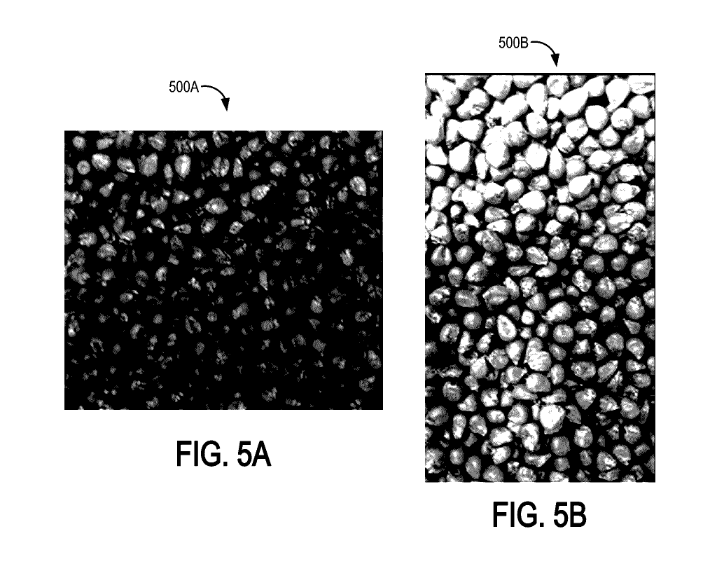

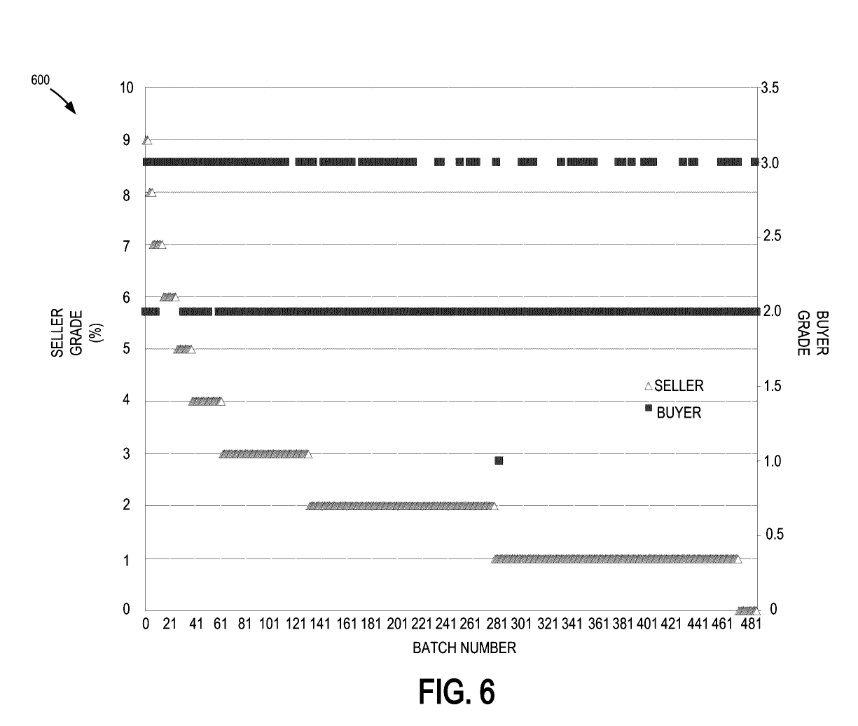

In embodiments, when comparing an amount of one or more colors to one or more thresholds, the grading instructions 120 may include instructions that instruct the processing device 110 to determine whether an amount of one or more colors is less than or greater than a color threshold when performing the comparison of the amount of one or more colors to a color threshold. The color thresholds that are configured are referred to herein as threshold test(s). As an example, if the processing device 110 determines the digital image and/or a section of the digital image to have an amount of red, the processing device 110 may determine whether the amount of red is greater than a red threshold (e.g., 90 on an 8-bit scale). As another example, if the processing device 110 determines the digital image and/or a section of the digital image to have an amount of blue, the processing device 110 may determine whether the amount of blue is less than a blue threshold (e.g., 70 on an 8-bit scale). However, this is only an example and, as stated above, the thresholds may be configurable based on achieving different desirable colors. As discussed below in relation to FIG. 6, it has been found that determining a section has greater than 90 (on an 8-bit scale) red and less than 70 (on an 8-bit scale) blue corresponds to the section having an inadequate level of yellowish-brown color seeds for some seeds wholesalers. In embodiments, the threshold tests (e.g., the color thresholds) may be configurable based on a desired amount of color and/or may be adjusted up or down depending on the calibration parameters, as descried below in relation to FIGS. 5A-5B.

In embodiments, the grading instructions 120 may include instructions that instruct the processing device 110 to group each segment into one or more groups based on whether the amount of the one or more colors of the segment was more than the threshold test or was less than the threshold test. For example, there may be two groups, a desirable group and an undesirable group; and, if the amount of color of a segment exceeds a threshold, then the segment may be grouped into a first, undesirable group; if, however, the amount of color of a segment does not exceed a threshold, then the segment may be grouped into a second, desirable group. In embodiments, there may only be one group (i.e., either a desirable group or an undesirable group).

In embodiments, the grading instructions 120 may include instructions that instruct the processing device 110 to determine an amount of sections (e.g., pixels) of the total amount sections (e.g., the total amount of the digital image's constituent pixels) that include an amount of one or more colors that are either greater than one or more thresholds and/or less one or more thresholds. That is, the processing device 110 may be configured to determine how many sections out of the total number of sections either “pass” or do not “pass” the threshold test for which the processing device 110 is testing. For example, assume the processing device 110 is configured to determine how many sections include an amount of red that is greater than 90 (on an 8-bit scale) and an amount of blue that is less than 70 (on an 8-bit scale), which for this example indicates a section does not pass the threshold test. As such, if a first section includes an amount of red that is greater than 90, but an amount of blue that is greater than 70, the first section may be included in the sections that pass the threshold test. Further, if a second section includes an amount of red that is less than 90 (on an 8-bit scale) and an amount of blue that is less than 70 (on an 8-bit scale), the second section may be included in the sections that pass the threshold test. Moreover, if a third section includes an amount of red than is less than 90 (on an 8-bit scale) and an amount of blue that is greater than 70 (on an 8-bit scale), the third section may be included in the sections that pass the threshold test. Alternatively, if a fourth section includes an amount of red than is greater than 90 (on an 8-bit scale) and an amount of blue that is less than 70 (on an 8-bit scale), the fourth section may not be included in the sections that pass the threshold test. In embodiments, the amount of sections that either passed or failed the threshold test may be expressed as a percentage.

In embodiments, the grading instructions 120 may include instructions that instruct the processing device 110 to determine whether the amount of sections of the total amount of sections that passed the threshold test exceeds a pass threshold. As used herein, the term “grading” the seeds is when the processing device 110 determines whether the amount of sections that have passed (or failed) the threshold test exceeds (or is less than) a pass threshold. For example, the pass threshold may be set at 60%, 62%, 64%, 66%, 68%, 70%, 72%, 74%, 76%, 78%, 80%, 82%, 84%, 86%, 88%, 90%, 92%, 94%, 96%, 98% and/or the like. As discussed below in relation to FIG. 6 below, it has been found that when a digital image includes equal to or less than 8% of sections that have yellowish-brown coloring (i.e., equal to or greater than 92% of sections that do not have yellowish-brown coloring), as determined when a section includes greater than 90 (on an 8-bit scale) red and less than 70 (on an 8-bit scale) blue, some wholesalers found the seeds to be of acceptable desirable coloring. In embodiments, the pass threshold may be configurable and/or may be adjusted up or down depending on the calibration parameters, as descried below in relation to FIGS. 5A-5B.

Additionally or alternatively, the grading instructions 120 may include instructions that instruct the processing device 110 to output to the display device 114 a signal corresponding to the comparison of the amount of color to the color threshold and/or whether the comparison indicates a threshold number of sections have passed the threshold test(s).

In embodiments, the processing device 110, the memory 118, the display device 114 and the digital camera 104 can be coupled together, directly and/or indirectly, by a bus 122, as shown in FIG. 1. In these embodiments, the digital image can be processed by the processing device 110, according to the grading instructions 120, at the same location as the digital image was taken by the digital camera 104. An example of this situation may be when seeds 102 are being stored and graded in a warehouse. As another example, seeds 102 may be grown in a field and a person may take a digital image of the seeds 102 with a computing device 108 (e.g., a smartphone), which then grades the seeds 102, according to the grading instructions 120. Any number of additional components, different components, and/or combinations of components may also be coupled to the processing device 110, memory 118 and display device 114, via the bus 122. The bus represents what may be one or more busses (such as, for example, an address bus, data bus, or combination thereof).

FIG. 2 is a block diagram depicting another system 200 for grading the appearance of seeds 102. Components of the system 200 with the same or similar numbers (e.g., 114 vs. 114A) as the components depicted in system 100 represent the same or similar components and have similar functions. Additionally or alternatively to system 100, the digital camera 10 and display device 114A depicted in FIG. 2 may be coupled to a network adapter 124A. In these embodiments, the network adapter 124A can communicate with a second network adapter 124B over one or more wired and/or wireless networks 126. The second network adapter 124B can be in communication with a second display device 114B, the processing device 110 and the memory 118. In these embodiments, the digital image can be processed by the processing device 110, according to the grading instructions 120, at a different location than the digital image was taken by the digital camera 104. An example of this situation is when a digital image is taken of seeds 102 that are growing in a field and the digital image is transferred to a processing device 110 located at another location, e.g., in a company's headquarters. In embodiments, the network 126 may the Internet. In embodiments, the network 126 may use dedicated or private communication links (e.g., WAN, MAN, LAN) that are not necessarily part of the Internet. The network 126 can use standard communications technologies and/or protocols.

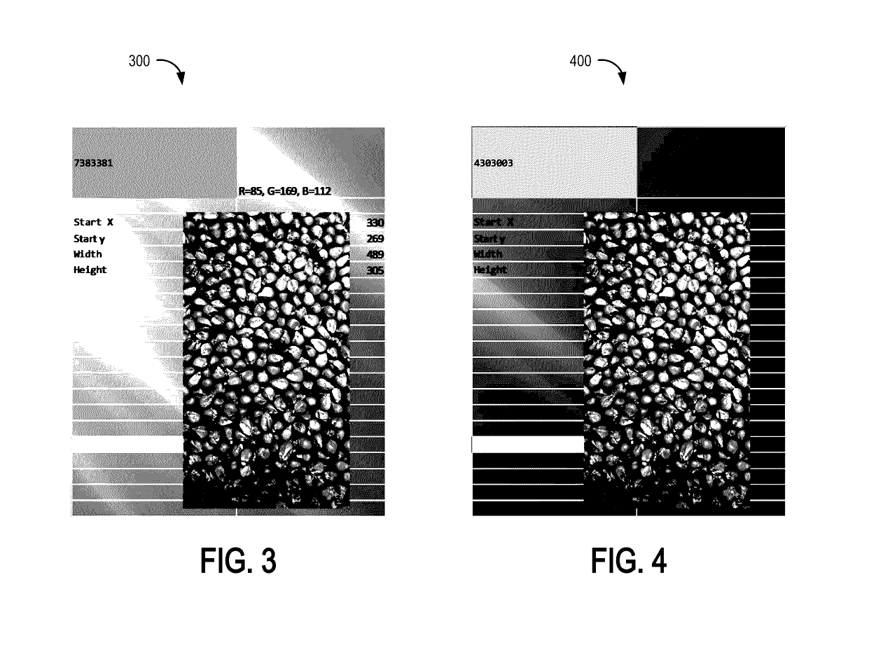

FIGS. 3-4 are images 300, 400 of two sets of seeds that are graded, in accordance with embodiments of the present invention. Data indicative of both images 300, 400 are received by a processing device (e.g., the processing device 110 of FIGS. 1 and 2) and divided into segments by the processing device. In this example, the images 300, 400 are divided into the images' 300, 400 constituent pixels. Further, in embodiments, the processing device may determine an amount of color in each pixel of each image 300, 400. In embodiments, when determining an amount of color in each pixel, the processing device may be configured to determine the 8-bit representation of the one or more primary colors in a section (i.e., pixel) of the image.

Moreover, in embodiments, the processing device may compare an amount of color in a section to a color threshold. Assume in this example the desirable color is green and the undesirable color is a yellowish-brown. Accordingly, the processing device may compare an amount of red in a section to a red threshold set at 90 and compare an amount of blue in a section to a blue threshold set at 70. If a section (i.e., pixels) includes an amount of red that is greater than 90 (on an 8-bit scale) and an amount of blue that is less than 70 (on an 8-bit scale), the section may include an amount of a yellowish-brown color that is undesirable. Accordingly, the processing device may be configured to determine a section that includes an amount of red that is greater than 90 (on an 8-bit scale) and an amount of blue that is less than 70 (on an 8-bit scale) does not pass the threshold test.

In both images 300, 400, an amount color in pixel 330×269 is currently being determined. Referring to FIG. 3, the amount of red is 85, which is less than 90, and the amount of blue is 112, which is greater than 70. Accordingly, pixel 330×269 of FIG. 3 passes the threshold test. Referring to FIG. 4, the amount of red is 155, which is greater than 90, and the amount of blue is 65, which is less than 70. Accordingly, pixel 330×269 of FIG. 4 does not pass the threshold test. This process may be repeated for all the pixels in both images 300, 400 or a subset of pixels in both images 300, 400.

In embodiments, the sections that do not pass the threshold test (e.g., pixel 330×269 of FIG. 4) may be counted by the processing device. After which, the processing device may be determine how many sections out of the total number of sections do not pass the threshold test. If the amount of sections that do not pass the threshold test exceeds a threshold percentage (e.g., 8%), the processing device may determine that seeds will not satisfy a purchaser's standards and, therefore, the seeds need to be resprayed.

In embodiments, the processing device may output to a display device a signal indicating the amount of sections that have either passed or failed the threshold test(s), the amount of sections that have passed or failed the threshold test(s) as a percentage of the total number of sections, a pass rating indication for the seeds if the amount of sections that have passed the threshold test is greater than the threshold percentage and/or a fail rating indication for the seeds if the amount of sections that have passed the threshold test is less than the threshold percentage.

FIGS. 5A-5B are images 500A, 500B of a single set of seeds that were imaged using different calibration parameters. As shown, the image 500A of the seeds depicted in FIG. 5A appears to be darker than the image 500B of the seeds depicted in FIG. 5B. In embodiments, one digital image 500A, 500B may be a more accurate representation of the seeds than the other digital image 500A, 500B. To determine which of the digital images 500A, 500B is a more accurate representation of the seeds, the seeds may be graded by one or more external sources. For example, in embodiments, the one or more external sources may be one or more humans that assign the set of seeds a grade after viewing the actual seeds, not images of the seeds. In embodiments, the one or more humans may be one or more sellers and one or more buyers of the seeds. In embodiments, the grades assigned by the one or more buyers and the one or more sellers may be agreed upon by both the one or more buyers and the one or more sellers. Examples of grades assigned by external sources may include, but are not limited to, poor, acceptable, marginal and excellent, where marginal, acceptable and excellent are passing grades and poor is a failing grade.

The grading(s) from the one or more external sources can then be compared to the gradings assigned to the seeds by the processing device (e.g., the processing device 110 depicted in FIGS. 1 and 2) by implementing the grading instructions (e.g., the grading instructions 120 depicted in FIGS. 1 and 2). If one of the images 500A, 500B is less closely aligned with the external grading of the seeds, the threshold tests and/or the pass threshold may be adjusted up and/or down, respectively. For example, instead of having red and blue thresholds set at 90 and 70, respectively, the red and blue thresholds may be set at, for example, 95 and 75, respectively. Additionally or alternatively, in embodiments, instead of having a pass threshold set to less than or equal to 8%, the pass threshold may be set to less than or equal to 6%.

In embodiments, the calibration parameters may be correlated to a specific location and environment (e.g., a specific warehouse). In embodiments, if the location or environment changes, then the calibration parameters may be need to adjusted up or down again using, for example, grades by an external source.

In embodiments, the calibration parameters may be received by the processing device and/or stored in memory (e.g., the memory 118 depicted in FIGS. 1 and 2). Then, if an image of seeds is taken in the future using the same calibration parameters, the processing device may be configured to adjust the threshold tests and/or the pass threshold up and/or down, respectively, in the same manner that the threshold tests and/or the pass threshold was previously adjusted when compared to the external grading. Accordingly, an external grading may not be necessary going forward since the threshold tests and/or the pass threshold can be adjusted automatically by the processing device based on the previous comparison between the external grading(s) and the grading assigned to the seeds by the processing device.

Additionally or alternatively, a plurality of digital images of seeds may be taken with a digital camera (e.g., the digital camera 104 depicted in FIGS. 1 and 2) while varying the calibration parameters. Each of the digital images taken can be assigned a grade according to the amount of a color(s) in each of the digital images. Further, the seeds in each of the digital images can be assigned an optimal grade that is determined using ideal calibration parameters and/or agreed upon by both a buyer and seller of the seeds. After which, each of the plurality of digital images and their respective optimal grades, assigned grades and calibration parameters may be assigned a respective calibration number. The calibration number may be sued to determine whether a digital image taken using the calibration parameters needs to be adjusted up or down to reflect the optimal grade. In embodiments, the adjustment up or down may be adjusting the threshold test(s) and/or the pass threshold discussed.

FIG. 6 is a chart 600 illustrating, for a plurality of sample sets of seeds, a comparison between a seller's grade of a sample set of seeds using the embodiments disclosed herein and a buyer's grade for the same set of seeds. In this example, sections having a yellowish-brown color were determined. A section was determined to have a yellowish-brown color when a section had an amount of red, on an 8-bit scale, that was greater than 90 and an amount of blue, on an 8-bit scale, that was less than 70. The pass threshold was set at 8%. That is, if more than 8% of the sections were found to have an amount of red greater than 90 and an amount of blue less than 70, then the seeds were assigned a failing grade. If, however, less than or equal to 8% of the sections were found to either have an amount of red less than 90 or an amount of blue greater than 70, or both, then the seeds were assigned a passing grade. The seeds assigned a passing grade were shipped to the buyer. The buyer then assigned a grading to the seeds. The buyer's grading was on a 1-4 scale. 1 being the best, perfect appearance, 2 being acceptable, 3 being marginal and 4 being the worst, denoting a failure. If the buyer received any seeds that they graded as a 4, the buyer found the seeds unacceptable and would likely reject the shipment of seeds. If the buyer received seeds that they graded a 3 or below, they would likely accept the shipment of seeds. As such, the seller wanted to only ship seeds that the buyer would grade as a 3 or lower. Using the embodiments presented herein and based on the 8% pass threshold, the seller was able to only ship seeds that the buyer found acceptable. In embodiments, if seeds were assigned a poor grading, mechanical settings to the equipment could be adjusted, the amount of seeds per filled bin could be decreased and/or cosmetic rates (e.g., the amount of spray that is added to the seeds could be increased).

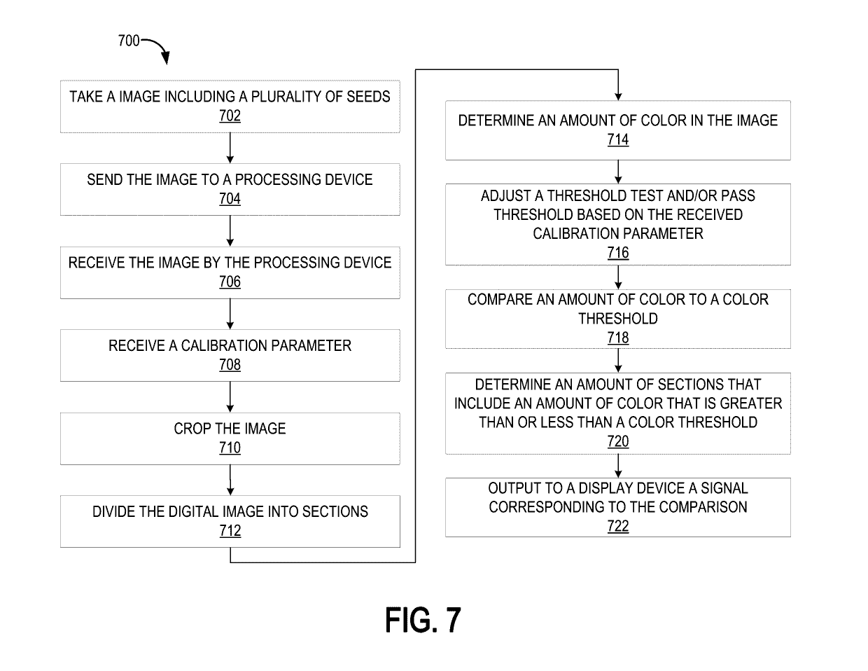

FIG. 7 is a flow diagram depicting a processor-implemented method 700 for grading the appearance of seeds, in accordance with embodiments of the present invention. In embodiments, method 700 may be included in the grading instructions (e.g., the grading instructions 120 depicted in FIGS. 1 and 2), stored on memory (e.g., the memory 118 depicted in FIGS. 1 and 2) and executed by a processing device (e.g., the processing device 110 depicted in FIGS. 1 and 2), in order to grade the appearance of the seeds.

In embodiments, method 700 may include taking an image, wherein the image includes a plurality of seeds (block 702). In embodiments, a digital camera (e.g., the digital camera 104 depicted in FIGS. 1 and 2) may be used to take the digital image that includes the plurality of seeds. When the digital image is taken, a plurality of calibration parameters may be determined. The calibration parameters include, but are not limited to, the amount of light incident on the seeds, the angle of the digital camera relative to the seeds, the distance of the digital camera from the seeds, the amount of light incident on the seeds, an angle of the digital camera relative to the seeds, a distance of the digital camera from the seeds, the digital camera characteristics, focal length of the digital camera, aperture of the digital camera, shutter speed of the digital camera, sensitivity/ISO of the digital camera, white balance of the digital camera, focus area of the digital camera and focus mode of the digital camera. These calibration parameters may be sent to a processing device and used when grading the color of the seeds.

In embodiments, method 700 may include sending the image to a processing device (block 704) and receiving the image by the processing device (block 706). In embodiments, the processing device may be the same or similar to the processing device 110 depicted in FIG. 1 and have some or all of the same functionality. In embodiments, the processing device may receive the calibration parameters of the digital camera used to take the digital image (block 708).

In embodiments, method 700 may include cropping the image (block 710). In embodiments, cropping the digital image may be the same or similar to the embodiments described above in to FIGS. 1 and 2 for cropping the digital image. For example, the image may be cropped to a standardized size. For example, the method 700 may include cropping the digital image to 100×100 pixels, 200×200 pixels, 300×300 pixels, 300×200 pixels, 400×300 pixels and/or the like. However, this is only an example and not meant to be limiting. Additionally or alternatively, in embodiments, if the digital image contains portions that do not include the seeds, the method 700 may include determining which portions of the digital image include the seeds using, for example, one or more edge detection algorithms, and crop out the portions of the digital image that do not include the seeds.

In embodiments, method 700 may include dividing the digital image into sections (block 712). In embodiments, dividing the digital image into sections may be the same or similar to the embodiments described above in relation to FIGS. 1 and 2 for dividing the digital image into sections. For example, method 700 may include dividing the digital image into the digital image's constituent pixels. That is, if a digital image is 100×100 pixels, the digital image will have 10,000 segments after the received digital image is divided. As another example, the method 700 may include dividing the digital image into 2×2 sections, 4×4 sections, 6×6 sections, 8×8 sections, 10×10 sections and/or the like. That is, if the digital image is 100×100 pixels, and the method 700 includes dividing the digital image into 20×20 sections, each section will be 5×5 pixels. As even another example, the method 700 may include dividing the digital image into sections based on resulting size of the divided section. For example, the method 700 may include dividing the digital image into sections, wherein each section is 2×2 pixels. Accordingly, if the digital image is 100×100 pixels, then the method 700 may include dividing the digital image into 2,500 sections. Alternatively, if the digital image is 200×200 pixels, then the method 700 may include dividing the digital image into 10,000 sections. However, these are only examples and not meant to be limiting. Instead, the digital image may be divided into sections using any other known method.

In embodiments, method 700 may include determining an amount of one or more colors in the digital image (block 714). In embodiments, determining an amount of one or more colors in the digital image may be the same or similar to the embodiments described above in relation to FIGS. 1 and 2 for determining an amount of one or more colors in the digital image. For example, the method 700 may include determining an amount of color in each section or a subset of sections of the digital image. To determine an amount of color in a section and/or a subset of sections, the method 700 may include determining the 8-bit number that represents an amount of a primary color included in the section. For example, the method 700 may include determining an amount of one or more primary colors included in each pixel of the digital image. In embodiments, the amount of one or more primary colors may be based on the 256×256×256 scale (i.e., on an 8×8×8 bit scale). That is, each primary color may be represented by 1 of 256 different numbers, which corresponds to a specific amount of the primary color in the pixel.

In embodiments, method 700 may include adjusting a threshold test and/or a pass threshold based on received calibration parameters (block 716). In embodiments, adjusting a threshold test and/or a pass threshold based on received calibration parameters may be the same or similar to the embodiments described above in relation to FIGS. 1, 2 and 5A-5B for adjusting a threshold test and/or a pass threshold based on received calibration parameters. For example, a grading(s) from the one or more external sources may be compared to the gradings assigned to the seeds by the method 700. If an image is less closely aligned with the external grading of the seeds, the threshold tests and/or the pass threshold may be adjusted up and/or down, respectively. For example, instead of having red and blue thresholds set at 90 and 70, respectively, the red and blue thresholds may be set at, for example, 95 and 75, respectively. Additionally or alternatively, in embodiments, instead of having a pass threshold set to less than or equal to 8%, the pass threshold may be set to less than or equal to 6%. Then, if an image of seeds is taken in the future using the same calibration parameters, the method 700 may include adjusting the threshold tests and/or the pass threshold up and/or down, respectively, in the same manner that the threshold tests and/or the pass threshold was previously adjusted when compared to the external grading.

Additionally or alternatively, a plurality of digital images of seeds may be taken with a digital camera (e.g., the digital camera 104 depicted in FIGS. 1 and 2) while varying the calibration parameters. Each of the digital images taken can be assigned a grade according to the amount of a color(s) in each of the digital images. Further, the seeds in each of the digital images can be assigned an optimal grade that is determined using ideal calibration parameters and/or agreed upon by both a buyer and seller of the seeds. After which, each of the plurality of digital images and their respective optimal grades, assigned grades and calibration parameters may be assigned a respective calibration number. The calibration number may be used to determine whether a digital image taken using the calibration parameters needs to be adjusted up or down to reflect the optimal grade. In embodiments, the adjustment up or down may include adjusting the threshold test(s) and/or the pass threshold.

In embodiments, method 700 may include comparing an amount of color to a color threshold (block 718). In embodiments, comparing an amount of color to a color threshold may be the same or similar to the embodiments described above in relation to FIGS. 1 and 2 for comparing an amount of color to a color threshold. For example, the method 700 may include comparing an amount of one or more colors (e.g., one or more of the determined amounts) in each section or subset of sections to a threshold. For example, if the digital image is divided into 100 sections, an amount of one or more colors in 25 sections, 50 sections, 75 sections, 100 sections and/or the like may be compared to a threshold.

In embodiments, comparing an amount of color to a color threshold (block 718) may include comparing an amount of one or more colors (e.g., the determined amount of one or more colors) to a respective threshold that corresponds to the respective color of the one or more colors. For example, the method 700 may include comparing an amount of red to a red threshold. Further, in embodiments, the method 700 may include comparing an amount of blue to a blue threshold. And, in embodiments, the method 700 may include comparing an amount of green to a green threshold. In embodiments, the threshold may be based on the 256×256×256 scale (i.e., on an 8×8×8 bit scale). For example, a red threshold, a green threshold and/or a blue threshold may be 10, 20, 30, 40, 50, 60, 70, 80, 90, 100, 110, 122, 130, 140, 150, 160, 170, 180, 190, 200, 210, 220, 230, 240, 250 and/or the like.

In embodiments, when comparing an amount of one or more colors to one or more thresholds, the method 700 may include determining whether an amount of one or more colors is less than or greater than a color threshold when performing the comparison of the amount of one or more colors to a color threshold. The color thresholds that are configured are referred to herein as threshold test(s). As an example, if the method 700 may include determining whether the amount of red is greater than a red threshold (e.g., 90 on an 8-bit scale). As another example, the method 700 may include determining whether the amount of blue is less than a blue threshold (e.g., 70 on an 8-bit scale). However, this is only an example and, as stated above, the thresholds may be configurable based on achieving different desirable colors. As discussed above in relation to FIG. 6, it has been found that determining a section has greater than 90 (on an 8-bit scale) red and less than 70 (on an 8-bit scale) blue corresponds to the section having an inadequate level of yellow-brownish color seeds for some seeds wholesalers. In embodiments, the threshold tests (e.g., the color thresholds) may be configurable based on a desired amount of color and/or may be adjusted up or down depending on the calibration parameters, as descried above in relation to FIGS. 5A-5B.

In embodiments, the method 700 may include grouping each segment into one or more groups based on whether the amount of the one or more colors of the segment was more than the threshold test or was less than the threshold test. For example, there may be two groups, a desirable group and an undesirable group; and, if the amount of color of a segment exceeds a threshold, then the segment may be grouped into a first, undesirable group; if, however, the amount of color of a segment does not exceed a threshold, then the segment may be grouped into a second, desirable group. In embodiments, there may only be one group (i.e., either a desirable group or an undesirable group).

In embodiments, the method 700 may include determining an amount of sections (e.g., pixels) of the total amount sections (e.g., the total amount of the digital image's constituent pixels) that include an amount of one or more colors that are either greater than one or more thresholds and/or less one or more thresholds (block 720). That is, the method 700 may include determining how many sections out of the total number of sections either “pass” or do not “pass” the threshold test for which the method 700 is testing. In embodiments, determining an amount of sections that include an amount of one or more colors that are either greater than one or more thresholds and/or less one or more thresholds may be the same or similar to the embodiments described above in relation to FIGS. 1, 2 and 5A-5B for determining an amount of sections that include an amount of one or more colors that are either greater than one or more thresholds and/or less one or more thresholds.

For example, assume method 700 determines how many sections include an amount of red that is greater than 90 (on an 8-bit scale) and an amount of blue that is less than 70 (on an 8-bit scale), which for this example indicates a section does not pass the threshold test. As such, if a first section includes an amount of red that is greater than 90, but an amount of blue that is greater than 70, the first section may be included in the sections that pass the threshold test. Further, if a second section includes an amount of red that is less than 90 (on an 8-bit scale) and an amount of blue that is less than 70 (on an 8-bit scale), the second section may be included in the sections that pass the threshold test. Moreover, if a third section includes an amount of red than is less than 90 (on an 8-bit scale) and an amount of blue that is greater than 70 (on an 8-bit scale), the third section may be included in the sections that pass the threshold test. Alternatively, if a fourth section includes an amount of red than is greater than 90 (on an 8-bit scale) and an amount of blue that is less than 70 (on an 8-bit scale), the fourth section may not be included in the sections that pass the threshold test. In embodiments, the amount of sections that either passed or failed the threshold test may be expressed as a percentage.

In embodiments, when determining an amount of sections that include an amount of one or more colors that are either greater than one or more thresholds and/or less one or more thresholds, method 700 may include determining whether the amount of sections of the total amount of sections that passed the threshold test exceeds a pass threshold. As used herein, the term “grading” the seeds is when the method 700 determines whether the amount of sections that have passed (or failed) the threshold test exceeds (or is less than) a pass threshold. For example, the pass threshold may be set at 60%, 62%, 64%, 66%, 68%, 70%, 72%, 74%, 76%, 78%, 80%, 82%, 84%, 86%, 88%, 90%, 92%, 94%, 96%, 98% and/or the like. As discussed above in relation to FIG. 6 below, it has been found that when a digital image includes equal to or less than 8% of sections that have yellowish-brown coloring (i.e., equal to or greater than 92% of sections that do not have yellowish-brown coloring), as determined when a section includes greater than 90 (on an 8-bit scale) red and less than 70 (on an 8-bit scale) blue, some wholesalers found the seeds to be of acceptable desirable coloring. In embodiments, the pass threshold may be configurable and/or may be adjusted up or down depending on the calibration parameters, as descried above in relation to FIGS. 5A-5B.

In embodiments, method 700 may include outputting to the display device (e.g., the display device 114 depicted in FIGS. 1 and 2) a signal corresponding to the comparison of the amount of color to the color threshold and/or whether the comparison indicates a threshold number of sections have passed the threshold test(s).

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Accordingly, the scope of the present disclosure is intended to embrace all such alternatives, modifications, and variations as fall within the scope of the claims, together with all equivalents thereof.

We claim:

1. A system for grading the appearance of seeds, the system comprising:
a memory device configured to store one or more color thresholds;
a processing device communicatively coupled to the memory device, the processing device configured to:
receive data corresponding to a digital image, wherein at least a portion of the digital image includes a representation of a plurality of seeds;
divide the digital image into a plurality of sections; and
compare an amount of color included in a section of the plurality of sections to a color threshold of the one or more color thresholds.

2. The system of claim 1, wherein the processing device is configured to crop portions of the digital image that do not include the representation of the plurality of seeds.

3. The system of claim 1, wherein the processing device is configured to compare an amount of color included in a section to a color threshold for all of the plurality of sections.

4. The system of claim 1, wherein to divide the digital image into a plurality of sections, the processing device is configured to divide the digital image into the digital image's constituent pixels.

5. The system of claim 1, wherein to compare an amount of color included in a section to a color threshold, the processing device is configured to compare one or more amounts of one or more primary colors included in a section to one or more color thresholds.

6. The system of claim 5, wherein to compare the one or more amounts of one or more primary colors included in a section to one or more color thresholds, the processing device is configured to compare the one or more amounts to one or more respective color thresholds of the one or more color thresholds.

7. The system of claim 6, wherein to compare the one or more amounts to one or more respective color thresholds, the processing device is configured to:
compare an amount of red in a section to a red threshold; and
compare an amount of blue in a section to a blue threshold.

8. The system of claim 7, wherein to compare the amount of red in a section to a red threshold, the processing device is configured to determine when the amount of red in the section is greater than the red threshold; and wherein to compare the amount of blue in a section to a blue threshold, the processing device is configured to determine when the amount of blue in the section is less than the blue threshold.

9. The system of claim 8, wherein the red threshold is 90 on an 8-bit scale and the blue threshold is 70 on an 8-bit scale.

10. The system of claim 8, the processing device further configured to determine an amount of sections of the total amount of sections that include: an amount of red that is greater than the red threshold and an amount of blue that is less than the blue threshold.

11. The system of claim 10, wherein the processing device is further configured to output, to a display device, a signal indicating a pass rating when the determined amount of sections divided by the total amount of sections is less than a threshold percentage.

12. The system of claim 11, wherein the threshold percentage is 8%.

13. The system of claim 1, wherein the processing device is configured to receive at least one calibration parameter corresponding to the digital image.

14. The system of claim 13, wherein the processing device is configured to adjust the color threshold based on the received at least one calibration parameter.

15. The system of claim 13, wherein the at least one calibration parameter include at least one of: the amount of light incident on the seeds, an angle of the digital camera relative to the seeds, a distance of the digital camera from the seeds, the digital camera characteristics, focal length of the digital camera, aperture of the digital camera, shutter speed of the digital camera, sensitivity/ISO of the digital camera, white balance of the digital camera, focus area of the digital camera and focus mode of the digital camera.

16. A processor-implemented method for grading the appearance of seeds, the method comprising:
dividing, using a processing device, a digital image into a plurality of sections, wherein at least a portion of the digital image includes a representation of a plurality of seeds;
comparing, using the processing device, an amount of color included in a section of the plurality of sections to a color threshold of the one or more color thresholds; and
outputting, to a display device, a signal corresponding to the comparison of the amount of color to the color threshold.

17. The method of claim 16, further comprising taking the digital image using a digital camera and sending the digital image to the processing device.

18. The method of claim 16, further comprising cropping, using the processing device, portions of the digital image that do not include the representation of the plurality of seeds

19. The method of claim 16, wherein comparing an amount of color included in a section to a color threshold comprises comparing an amount of color to a color threshold for all of the plurality of sections; and wherein comparing an amount of color included in a section comprises comparing one or more amounts of one or more primary colors included in the section to one or more respective color thresholds.

20. A system for grading the appearance of seeds, the system comprising:
a memory device configured to store one or more color thresholds;
a processing device communicatively coupled to the memory device, the processing device configured to:
receive data corresponding to a digital image, wherein at least a portion of the digital image includes a representation of a plurality of seeds;
receive at least one calibration parameter corresponding to the digital image;
adjust a color threshold of the one or more color thresholds based on the received at least one calibration parameter; and
compare an amount of color of the digital image to the adjusted color threshold.
